(19) United States
(12) Patent Application Publication
(10) Pub. No.: US 2015/0124616 A1
(43) Pub. Date: May 7, 2015

(54) METHOD AND SYSTEM FOR SATELLITE BACKHAUL OFFLOAD FOR TERRESTRIAL MOBILE COMMUNICATIONS SYSTEMS

(71) Applicant: Hughes Network Systems, LLC, Germantown, MD (US)

(72) Inventors: Michael LOHMAN, Germantown, MD (US); Satyajit ROY, Gaithersburg, MD (US)

(21) Appl. No.: 14/534,156

(22) Filed: Nov. 5, 2014

Related U.S. Application Data
(60) Provisional application No. 61/900,375, filed on Nov. 5, 2013.

(51) Int. Cl. H04W 28/08; H04B 7/185; H04W 28/02

(52) U.S. Cl. CPC H04W 28/085; H04W 28/0231; H04B 7/185
USPC 370/235

(57) ABSTRACT

An approach for cost effective backhaul services in terrestrial mobile communications systems is provided. Data traffic over a terrestrial communications path between a cell site and a core network of a cellular communications network is monitored. The presence of a threshold level of congestion over the terrestrial communications path is determined. Appropriate portions of the data traffic for transfer to a satellite communications link between the cell site and the core network of the cellular communications network are determined. The determined portions of the data traffic are transferred from the terrestrial communications path to the satellite communications link. Once the threshold level of congestion over the terrestrial communications path has subsided, the determined portions of the data traffic are transferred from the satellite communications link back to the terrestrial communications path.

### RELATED APPLICATIONS

This application claims the benefit of the earlier filing date under 35 U.S.C. §119(e) of U.S. Provisional Application Ser. No. 61/900,375 (filed 2013 Nov. 5).

### BACKGROUND

Terrestrial communication systems continue to provide higher and higher speed and more data intensive multimedia services (e.g., voice, data, video, images, high definition media services, etc.) to end-users. Such services (e.g., Third Generation (3G) services and Fourth Generation (4G or LTE)) can also accommodate differentiated quality of service (QoS) across various applications. To facilitate this, terrestrial architectures are moving towards an end-to-end all-Internet Protocol (IP) architectures that unify the services, including voice, over the IP bearer. In parallel, mobile satellite systems are being designed to complement and/or co-exist with terrestrial coverage depending on spectrum sharing rules and operator choice. With the advances in processing power of desktop computers, the average user has grown accustomed to sophisticated applications and services (e.g., streaming video, radio broadcasts, video games, high definition media, etc.), which place tremendous strain on network resources. The Internet as well as other communications services rely on protocols and networking architectures that offer great flexibility and robustness. Such infrastructure, however, may be inefficient in supporting the demands and traffic loads of such sophisticated applications and services.

4G/LTE and other cellular data networks require a significant amount of backhaul bandwidth during peak times and a lower amount of bandwidth during other times. Deploying dedicated high-speed backhaul links, such as fiber, or high-speed microwave, to every tower, especially in suburban or remote areas is costly, yet cellular consumers demand high-speed services everywhere. Traditionally, satellite links have only been deployed to carry small amounts of dedicated traffic from cell-sites in extremely remote areas that cannot be connected by a terrestrial. The drawback of satellite is that it has a very long delay, compared to terrestrial links, and it has a higher cost per bit. What is needed, therefore, are more cost effective methods and systems for backhaul services in terrestrial mobile communications systems.

### SOME EXEMPLARY EMBODIMENTS

Embodiments of the present invention advantageously address the foregoing requirements and needs, as well as others, by providing a system and methods for more cost effective backhaul services in terrestrial mobile communications systems. According to example embodiments, both terrestrial links and satellite links are provided together to minimize the system backhaul costs. According to one example embodiment, an efficient decision process is implemented for determining times when backhaul data and/or subsets of backhaul data that will be sent over satellite links to alleviate congestion on terrestrial backhaul links. For example, the decision process may determine to send all backhaul data over satellite links during peak congestion (e.g., when the terrestrial link to a particular tower is overloaded), and/or may also send only data that belongs to applications that can tolerate the additional delay during such times of peak congestion.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a system for backhaul services in a terrestrial mobile communications system, in accordance with example embodiments of the present invention; and

FIG. 2 illustrates a flow chart depicting a decision process performed by the Decision Module (DM) to determine when to move IP flows from a terrestrial path to the satellite path, in accordance with example embodiments of the present invention.

### DETAILED DESCRIPTION

A system and methods for more cost effective backhaul services in terrestrial mobile communications systems are provided. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

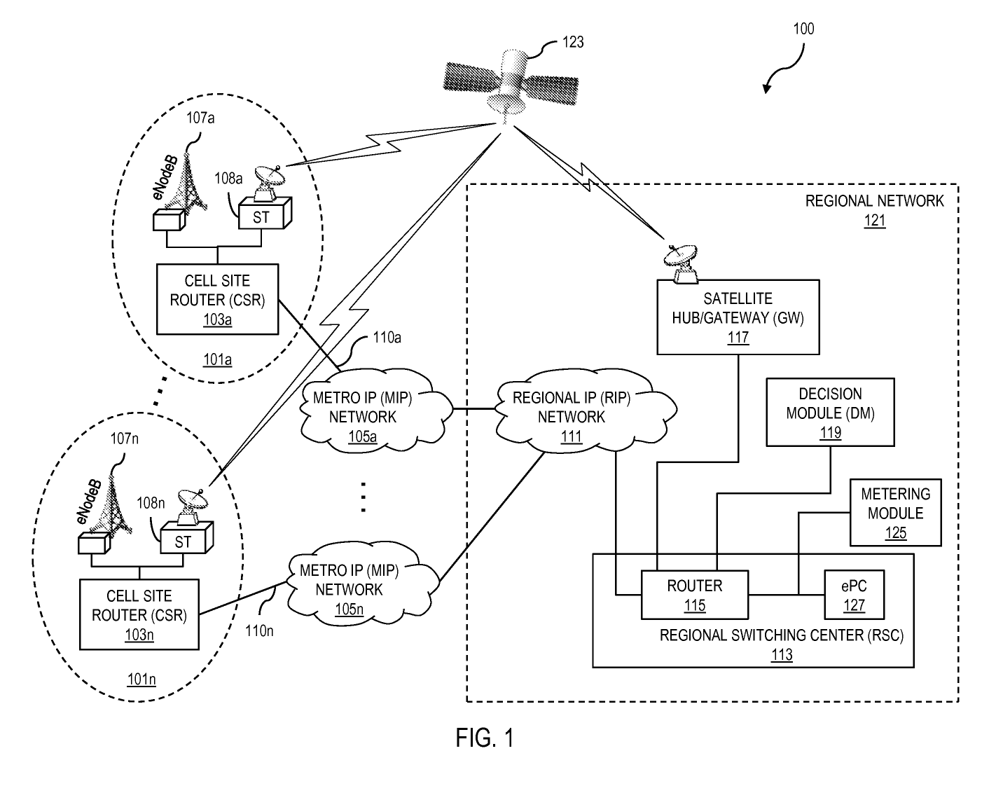

According to example embodiments of the present invention, FIG. 1 illustrates a block diagram of a system for backhaul services in a terrestrial mobile communications system. With reference to FIG. 1, the system 100 includes one or more cell sites 101a to 101n, a plurality of respective metro IP (MIP) networks 105a to 105n, a regional network 121 and at least one satellite 123. Each cell site includes a cell site router (CSR) (e.g., the cell sites 101a to 101n include the respective CSRs 103a to 103n), a cellular transmission/reception component (e.g., the cell sites 101a to 101n include the respective eNodeb's 107a to 107n) and a satellite terminal (ST) (e.g., the cell sites 101a to 101n include the respective STs 108a to 108n) Each of the MIP networks 105a to 105n comprises a local/wide area communications network (e.g., a fiber and/or microwave network) for communications between the respective cell site and the regional network 121. By way of example, the MIP network 105a may comprise a fiber network for backhaul services (for a particular geographical area, such as a metro area) between the respective cell site 101a and the regional network 121. A MIP network interfaces with the respective cell site via a respective last mile link (e.g., the last mile links 110a to 110n). Further, as would be readily apparent, although FIG. 1 depicts a single MIP network as the interface between a single cell site and the regional network, a single MIP network may provide for data communications between a plurality of cell sites of a geographic area and the regional network.

The regional network 121 includes a regional IP (RIP) network 111, a regional switching center (RSC) 113, a satellite hub/gateway (GW) 117 and a decision module (DM) 119. The RSC 113 serves as a main switching center for a respective geographical region. The RIP network comprises a long-haul terrestrial network (e.g., a wide area network or WAN) that connects a plurality of metro areas to the RSC 113. The RIP network 111, in conjunction with each MIP network, thereby provides for terrestrial data communications between the RSC 113 and the respective cell site (e.g., the RIP network 111, in conjunction with the MIP network 105a, provides for terrestrial data communications between the RSC 113 and the cell site 101a). By way of example, the RIP network 111, in conjunction with the MIP networks 105a to 105n may provide backhaul services between the RSC 113 and the respective cell sites 101a to 101n.

Similar to the RIP network 111, the satellite GW 117 comprises a satellite gateway that provides for data communications between the RSC 113 and the cell sites 101a to 101n. More specifically, the RSC 113 transmits/receives data to/from the CSR of a cell site, over communications channels of the satellite 123, via the satellite GW 117 and the ST of the respective cell site. By way of example, the GW 117 thereby provides for backhaul services between the RSC 113 and the cell sites 101a to 101n, such as transmitting data traffic in the outroute direction to the cell sites 101a to 101n and receiving data traffic in the inroute direction from the cell sites 101a to 101n.

The RSC 113 comprises a router 115, which serves as the interface for routing data either via the RIP network 111 or the satellite GW 117. The RSC 113 further comprises an evolved packet core (ePC) 127. The DM 119 determines the appropriate path for data traffic to the cell sites 101a to 101n, and commands the router 115 accordingly. The router 115 at the RSC 113 routes data to either the RIP network 111 or the satellite GW 117 based on commands from the DM 119. According to one embodiment, the DM monitors congestion over the terrestrial communication paths between the RSC 113 and the cell sites 101a to 101n. Congestion may occur at various places between the RSC and a particular cell site, such as congestion over the respective last mile link, the respective MIP network or the RIP network (or a combination thereof)—however, based on the scale of such network links, congestion would most readily occur over the last mile link. Then, based on the monitored congestion conditions, and the type of traffic (e.g., the respective application), the DM 119 would make decisions on whether to route particular IP flows or data traffic to the respective cell site(s) via the satellite GW 117 instead of the respective terrestrial path(s) (the RIP network MIP network last mile link path(s)). By way of example, an IP flow may comprise an IP socket, consisting of a unique source and destination address and IP port number. By way of further example, the DM may move particular IP flows, or particular data traffic (e.g., associated with particular applications), over the satellite based on congestion and flow application. In accordance with example embodiments, therefore, the DM 119 may perform the following functions: Detection of congestion over the respective terrestrial path(s) between the RSC 113 and the cell sites (e.g., detection of congestion over the respective last mile link between the CSR of a cell site and the respective MIP network); when congestion is detected, determine which traffic or IP flows can be moved from the congested terrestrial path(s) to satellite link(s); transfer the determined flow(s) to the satellite link(s); and transfer IP flows back from the satellite link(s) to the respective terrestrial network path(s) when the congestion ends.

In an LTE or 4G network, the Evolved Packet Core (ePC) comprises (not shown in the figures) the Home Subscriber Server (HSS), the Packet Data Network Gateway (p-GW), the Serving Gateway (S-GW), the Mobility Management Entity (MME), and the Policy Control and Charging Rules Function (PCRF). The MME manages session states and authenticates and tracks a user across the network. The S-GW routes data packets through the access network. The p-GW acts as the interface between the LTE network and other packet data networks, and manages quality of service (QoS) and provides deep packet inspection (DPI). The PCRF supports service data flow detection, policy enforcement and flow-based charging. The evolved packet core (ePC) 127 communicates with external packet data networks, such as the Internet, private corporate networks or the IP multimedia subsystem.

An IP packet for a user terminal (UE) is encapsulated in an ePC-specific protocol and tunneled between the P-GW and the eNodeB for transmission to the UE. A 3GPP-specific tunnel protocol called the GPRS Tunneling protocol (GPRS) is used over the S1 interface. The GPRS Tunneling protocol is IP/UDP based protocol, which encapsulates user data when passing through the core network. The following provides an example of GTP-U encapsulation of UE user plane traffic when an IP packet generated by a UE reaches the eNodeB and is forwarded to SGW. A TCP/IP packet generated by a UE application consists of a TCP or UDP header, IP field information (which has the source address of UE and destination address of the application server) and the application data. When the eNodeB receives this packet over the air interface, it encapsulates the packet with a GTP header, which contains information related to tunnel IDs. The packet is further encapsulated with UDP and IP headers and forwarded as an Ethernet frame towards the SGW. The IP header contains the eNodeB IP as a source address and SGW IP as a destination address.

A transport bearer is uniquely identified by the GTP tunnel endpoints and the IP address (e.g., source and destination Tunneling End ID [TEID] —carried inside the GTP header, source and destination IP address—carried inside the outer IP header). Multiple applications may be running in a UE at the same time and each one may have different QoS requirements. In order to support multiple QoS requirements, different EPS bearers are set up within the Evolved Packet System (EPS). Each bearer can carry one single IP flow or multiple IP flows with the same QoS requirements. An EPS virtual connection or “EPS bearer” is characterized by: the two endpoints; a QoS Class Index (QCI) that describes the type of service that makes use of the virtual connection (e.g. conversational voice, streaming video, signaling, best effort, etc.); (optionally) a flow specification that describes the guaranteed and maximum bitrate (GBR, MBR) of the aggregate traffic flow that goes through the virtual connection; and a filter specification called Traffic Flow Templates (TFTs) that describes the IP traffic flows for which the transport service is provided between the two endpoints. User IP packets are filtered into the appropriate EPS bearer. The TFTs use IP header information such as source and destination IP address and TCP/UDP port numbers to filter packets such as VoIP from web browsing traffic, so that each can be sent down the respective bearer with appropriate QoS. An Uplink TFT associated with each bearer in the UE filters packets to EPS bearers in the uplink direction. A Downlink TFT in the P-GW is a similar set of downlink packet filters. Each QCI is characterized by priority, packet delay budget and acceptable packet loss rate.

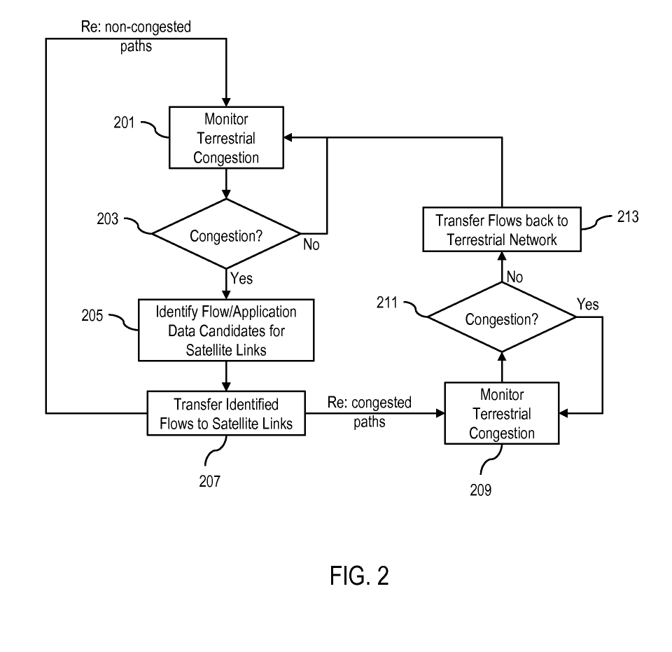

FIG. 2 illustrates a flow chart depicting a decision process performed by the DM to determine when to move IP flows from a terrestrial path to the satellite path, in accordance with example embodiments of the present invention. At step 201, the DM monitors congestion over the terrestrial data paths. At step 203, the DM determines whether congestion is present over any terrestrial paths between the RSC 113 and respective cell sites. If it is determined that there is no congestion present on any such terrestrial paths, then the process returns to step 201, whereby the DM continues to monitor for terrestrial congestion. Alternatively, if it is determined that congestion exists on one or more particular terrestrial paths between the RSC and one or more respective cell sites, then the DM determines or identifies particular IP flow or application data candidates for transmission via satellite channels or links (step 205). Then, at step 207, the DM commands the router 115 to transfer the identified IP flow(s) or application data for transmission to the respective cell site(s) via the satellite GW 117 to the CSR(s) of the respective cell site(s) over satellite transmission channels. At step 209, the DM continues to monitor the terrestrial congestion with respect to the transferred path(s) (the transition from step 207 to step 209), and at step 211, the DM determines whether congestion is still present over the terrestrial paths for which the traffic was transferred to the satellite link(s). If the congestion persists, then the DM continues to monitor those channels (step 209). If the congestion has been alleviated, then the DM commands the router 115 to transfer the IP flows or application data back to the respective terrestrial network path(s). At the same time, with regard to the non-congested paths, the DM continues to monitor for terrestrial congestion (the return from step 207 to step 201).

In accordance with example embodiments, congestion may be detected through a number of different methods. Further, in order to facilitate a more accurate determination of congestion, the DM may employ a combination of the individual congestion detection mechanisms.

According to one embodiment, congestion may be based on observed traffic patterns (e.g., based on time of day, days of the week/year, and geographical regions). By way of example, the transfer of particular IP flows to satellite links may be based on the time of day and day of week. Further, multiple levels of IP flows may be transferred to satellite links at different times of day and days of week. According to one embodiment, time of day IP flow scheduling can be predetermined based on traffic patterns and programmed manually by an operator. According to a further embodiment, the DM may learn traffic patterns over time, and dynamically adjust time of day IP flow scheduling, accordingly. For the case where the DM learns the traffic pattern over time, the DM may poll the CSRs for statistics related to traffic bandwidth usage concerning the respective terrestrial network path over time. Once the time of day pattern is determined, every day during the appropriate periods of time, appropriate IP flows will be transferred to satellite links.

According to a further embodiment, congestion may be monitored or determined by periodically polling the respective CSRs for congestion statistics. For this congestion detection method, the DM polls the CSR for statistics related to the amount of usage on the backhaul link of the respective terrestrial network paths. For example, if a CSR reports that it is receiving data at a level that is near a predetermined/preprogrammed bottleneck capacity of the respective last mile link, then the link is considered congested. When the usage crosses the predetermined/preprogrammed threshold, the DM starts transferring appropriate IP flows to satellite links. There may be multiple thresholds, and as each threshold is crossed, the DM may transfer more IP flows to satellite links, and, as congestion reduces, the DM may transfer flows back to the respective terrestrial link(s). According to certain embodiments (e.g., depending capabilities of cell site equipment, such as cell site routers), it may be necessary to place an appliance at the cell site to perform some of statistics measurements and the appliance would periodically send the measured statistics to the DM. In one example, the appliance may use the satellite link (inroute) to send the statistics information to the DM. An example is provided here that illustrates how to determine bandwidth usage from a cisco router. Similar methods may be applied for other routers.

Interface use is the primary measure used for network measurements. The below formulas can be used, based on whether the connection measure is half-duplex or full-duplex. Shared LAN connections are generally half-duplex, because contention detection requires that a device listen before it transmits. WAN connections are generally full-duplex, because the connection is point-to-point, and both devices can transmit and receive at the same time because they know there is only one other device that shares the connection. Because second version Management Information Base (MIB-II) variables are stored as counters, the method generally takes two poll cycles and figures the difference between the two (hence, the delta used in the equation).

The below formulas employ the following variables:
ΔifInOctets: The Δ (difference) between two poll cycles of collecting the SNMP ifInOctets object, which represents the count of inbound octets of traffic.
ΔifOutOctets: The Δ (difference) between two poll cycles of collecting the SNMP ifOutOctets object, which represents the count of outbound octets of traffic.
IfSpeed: the speed of the interface, as reported in the SNMP ifSpeed object. Note: ifSpeed does not accurately reflect the speed of a WAN interface.

For half-duplex media, the following formula may be used for measurement of interface use:

$$\frac{( Δ ifInOctets + Δ ifOutOctets ) * 8 * 100}{( number of seconds in Δ ) * IfSpeed}$$

For full-duplex media, for example, with a full T−1 serial connection, the line speed is 1.544 Mbps. Therefore, a T−1 interface can both receive and transmit 1.544 Mbps for a combined possible bandwidth of 3.088 Mbps. The following formula may be used to calculate the interface bandwidth for full-duplex connections, where the larger of the in and out values are taken and an interface use percentage is generated.

$$\frac{max ( Δ ifInOctets + Δ ifOutOctets ) * 8 * 100}{( number of seconds in Δ ) * IfSpeed}$$

This method, however, hides the use of the direction with the lesser value and provides less accurate results. A more accurate method is to measure the input use and output use separately, with these formulas:

$$Input utilization = \frac{Δ ifInOctets * 8 * 100}{( number of seconds in Δ ) * IfSpeed}$$

$$Output utilization = \frac{Δ ifOutOctets * 8 * 100}{( number of seconds in Δ ) * IfSpeed}$$

These formulas are simplified, as they do not consider overhead associated with the protocol. For example, the Internet Engineering Task Force (IETF) publication, RFC 1757, provides Ethernet-utilization formulas that consider packet overhead.

According to a further embodiment, congestion may be monitored or determined by polling the router 115 at the RSC and aggregating statistics to calculate the congestion levels of respective terrestrial links. Using this method alleviates the necessity of employing an appliance at the CSR site or polling of the CSR. By way of example, such statistics are generally kept by standard routers, and so the DM can periodically poll the router 115 for this information. In the case that the router 115 does not collect such information, a metering module 125 can be added at the RSC 113 to perform the statistics collection. In one embodiment, the data need not pass through the metering module 125, but rather the metering module 125 need only receive the data on the interface and meter it (e.g., via an optical coupler on the interface between the router 115 and the ePC 127. Alternatively, the data traffic may pass through the metering module 125. The same bandwidth usage formulas described above may also be used for this method.

According to a further embodiment, congestion may be monitored or determined by sending pings or test messages to the CSRs and measuring the round trip delay of the respective terrestrial networks. When the round trip delay exceeds a configured threshold consistently over a certain period of time, the DM may conclude that a congestion condition exists. Again, the DM may employ several thresholds, and transfer appropriate IP flows based on the threshold level of congestion.

Further, according to an example embodiment, only IP flows that belong to applications that are delay insensitive are moved to the satellite path during congestion. By way of example, the application associated with an IP flow may be detected in a number of ways. In one example, a deep packet inspection (DPI) may be performed to determine the application, such as video streaming, etc. According to a further example, in the case of a 4G or LTE network, the application may be determined by inspecting the QCI (quality of class index) of the S1 interface between the ePC and the eNodeB. In a further example, the application may be determined by inspecting packet quality of service (QoS) parameters (if present) in the type of service (TOS) bits of the IP packets. In a further example, the application may be determined by monitoring the characteristics of the packets of each flow, such as packet size, packet periodicity and total bandwidth.

In accordance with example embodiments, once the DM detects/determines congestion conditions on a terrestrial network path, it may transfer IP flows or application data traffic to satellite links based on various methods. According to one method, the DM may transfer certain classes of traffic (which may comprise multiple IP flows) from the congested terrestrial path(s) to satellite links based on the respective QCIs (quality class indices). According to a further method, the DM may transfer certain individual IP flows from the congested terrestrial path(s) to satellite links based on the GTP (General Packet Radio Service (GPRS) Tunneling Protocol). According to a further method, the DM may transfer certain individual IP flows from the congested terrestrial path(s) to satellite links based on a deep packet Inspection (DPI).

Once congestion is detected (e.g., in the last mile link), the DM identifies traffic flows or sessions that could be diverted from the respective terrestrial path(s) to satellite links. The DM, for example, may determine to transfer IP flows (as opposed to individual packets) based on congestion and flow application. This provides for the advantage that, since the DM would thereby make one decision to move an IP flow (as opposed to making multiple decisions on an individual packet basis). Further, once a flow is moved, the jitter and delay will be consistent from packet to packet, which has several advantages based on the IP protocol and window sizing estimates. Further, only flows that belong to applications that are delay insensitive are transferred to satellite links (which flows can tolerate the transmission delays of a satellite channel). Further, the DM monitors when the terrestrial congestion subsides, and moves the associated transferred flows back to the respective terrestrial path(s). According to one embodiment, after detecting flows that are candidates for transfer to satellite links, the DM may transfer the identified flows in the order of highest to lowest required bandwidth.

According to one embodiment, in the case of the transfer of certain classes of traffic (which may comprise multiple IP flows) from the congested terrestrial path(s) to satellite links based on the respective QCIs (quality class indices), the DM moves LTE/4G classes of traffic from the congested terrestrial path(s) to satellite links. By way of example, the class of traffic is determined by the QCI (QoS Class of Index), as defined in the LTE standard. Each evolved packet service (EPS) bearer in LTE is associated with a QCI. The traffic associated with delay insensitive applications will be offloaded to the satellite links during congestion. The QCI is constant for a given IP flow, so this method actually moves all flows with a given QCI (e.g., within a bearer) at once to the satellite links.

By way of example, one method for transfer of classes of traffic flows consists of Differentiated Services Code Point (DSCP) tag based offloading. Pursuant to this method, user traffic between the ePC and the eNodeB are encapsulated in a GTP-U (GPRS Tunneling protocol—User plane) tunnel. Each EPS bearer maps to a GTP tunnel which carries all the flows of same QoS characteristics. A transport bearer may be uniquely identified by the GTP tunnel endpoints and the IP address, such as source and destination Tunneling End ID [TEID] (carried inside the GTP header), and/or source and destination IP address (carried inside the outer IP header). The packet gateway in the ePC 127 maps a flow to a bearer based on QCI and encapsulates in a GTP tunnel. At the same time, the gateway sets the type of service (TOS) bits in the outer IP header (for the GTP tunnel)—e.g., performing DSCP tagging of packets based on the QCI associated with the flow. For example, conversational voice/video, real time gaming, interactive data and bulk data are tagged with different DSCP code points. By way of example, the operator may configure the DM with a table that indicates which DSCP tagged flows (i.e., which classes of traffic) should be transferred to satellite link(s) during periods of congestion on the respective terrestrial path(s). When congestion occurs, the DM configures the policy based routing of the router, indicating packets with specific DSCP tags carried in the outer IP header to be routed towards the satellite GW 117 instead of the RIP network 111. If a TCP flow is moved and the packets are not encrypted, the DM may update the TCP window size to the end hosts as satellite is a high latency link.

By way of further example, a second method for transfer of classes of traffic flows consists of bearer-based offloading. Pursuant to this method, the DM snoops EPS bearer establishment activities, and the DM maintains QCI, tunnel end point identifiers and traffic flow templates information for each successful established bearer. The control packets between eNodeB and ePC are carried using GTP-C (GPRS tunneling protocol—control plane) tunneling. The DM configures the router 115 to receive GTP-C packets. It inspects EPS bearer establishment packets and sends packets back to the router 115. By way of example, the DM is located be placed at such a point in the traffic path within the ePC network so that it can see control packets in the clear. Note that the DM is not in the path of user data traffic. When congestion occurs, the DM looks into the QCIs of currently established bearers and identifies bearers whose flows can be routed over satellite links. For example (from the QCI table), delay-sensitive QCIs (such as conversational voice (QCI 1), conversational video (QCI 1), real-time gaming (QCI 3), IP multimedia subsystem (IMS) signaling (QCI 5)) are kept on the terrestrial path(s), and bearers carrying non-delay-sensitive QCIs (such as guaranteed bit rate (GBR) buffered video streaming (QCI 4), non-GBR buffered video streaming (QCI 7) and TCP based world wide web (www), email, FTP (QCI 8 and 9)) may be selected as candidates for transfer to satellite links. When a bearer is selected for transfer to a satellite link, all application flows belong to this bearer are routed over the satellite link. The DM configures or updates the policy based or normal routing tables of the router 115 so that the router can route specific GTP-U tunnels to the GW 117 for transmission over satellite channels. If a TCP flow is transferred and the packets are not encrypted, the DM may update the TCP window size to the end hosts as satellite is a high latency link.

According to a further embodiment, in the case of the transfer of certain individual IP flows from the congested terrestrial path(s) to satellite links based on the GTP (General Packet Radio Service (GPRS) Tunneling Protocol), the DM transfers individual IP flows from the respective congested terrestrial path(s) to satellite links, whereby the transfer does not encompass an entire EPS bearer. An EPS bearer contains a set of packet filters called TFTs (Traffic flow templates). TFTs contain packet filtering information to identify and map packets to specific bearers. A packet GW (p-GW) in the ePC 127 filters packets coming from external networks using TFTs. The DM snoops the respective EPS bearer establishment and thereby becomes aware of the TFTs on a specific bearer. Accordingly, after identifying the specific bearer candidate for transfer to satellite links, the DM may further identify individual flows within the bearer using the respective TFTs, and thereby is able to transfer a subset of the flows of the bearer to the satellite link(s).

According to a further embodiment, in the case of the transfer of certain individual IP flows from the congested terrestrial path(s) to satellite links (e.g., where the QCI may not be implemented in accordance with LTE specification recommendations), the transfer determinations may be made based on a deep packet Inspection (DPI). For this case, the DM may perform Deep Packet Inspection (DPI) on the actual user IP packets (inside the GTP tunnel) to determine application types (such as data sessions from voice and streaming video sessions). Additionally the DM may monitor characteristics of packet flows, such as packet size, packet periodicity and total bandwidth used to determine the candidate flows for transfer to satellite links. By way of example, to perform DPI, the DM may be in the path of data traffic flow, and may itself route appropriate flows to the satellite GW 117 for transmission over satellite link(s).

While exemplary embodiments of the present invention may provide for various implementations (e.g., including hardware, firmware and/or software components), and, unless stated otherwise, all functions are performed by a CPU or a processor executing computer executable program code stored in a non-transitory memory or computer-readable storage medium, the various components can be implemented in different configurations of hardware, firmware, software, and/or a combination thereof. Except as otherwise disclosed herein, the various components shown in outline or in block form in the figures are individually well known and their internal construction and operation are not critical either to the making or using of this invention or to a description of the best mode thereof.

In the preceding specification, various embodiments have been described with reference to the accompanying drawings. It will, however, be evident that various modifications may be made thereto, and additional embodiments may be implemented, without departing from the broader scope of the invention. The specification and drawings are accordingly to be regarded in an illustrative rather than restrictive sense.

What is claimed is:

1. A method comprising:
monitoring data traffic over a terrestrial communications path between a cell site and a core network of a cellular communications network;
determining a presence of a threshold level of congestion over the terrestrial communications path;
determining appropriate portions of the data traffic for transfer to a satellite communications link between the cell site and the core network of the cellular communications network; and
transferring the determined portions of the data traffic from the terrestrial communications path to the satellite communications link.

2. The method according to claim 1, further comprising:
determining that the threshold level of congestion over the terrestrial communications path has subsided; and
transferring the determined portions of the data traffic from the satellite communications link back to the terrestrial communications path.
